(19) United States
(12) Patent Application Publication
(10) Pub. No.: US 2026/0268544 A1
(43) Pub. Date: Sep. 10, 2026

(54) Multi-dimensional Symbol Mapping System and Method for Ganzhi Energy Relationship Research

(71) Applicant: HANYIN ZHANG, LAS VEGAS, NV (US)

(72) Inventor: HANYIN ZHANG, LAS VEGAS, NV (US)

(21) Appl. No.: 19/071,728

(22) Filed: Mar. 5, 2025

(51) Int. Cl. G06T 11/20

(52) U.S. Cl. CPC G06T 11/26; G06T 11/23

(57) ABSTRACT

This invention presents a Ganzhi Karma Structure Diagram (GKSD) system transforming traditional Chinese BaZi astrology elements into standardized graphics. The method establishes symbol systems mapping Heavenly Stems and Earthly Branches; identifies relationships; constructs diagrams with inner/outer circular structure; arranges elements by ICMPE layout principle; establishes connections; and adds status icons. It solves problems of vague expression and standardization in astrology, enabling precise cross-language knowledge transfer and providing new analytical tools.

### TECHNICAL FIELD

This invention relates to the field of visualization analysis of traditional Chinese Four Pillars BaZi astrology, particularly to a method for graphically expressing Heavenly Stems, Earthly Branches and their relationships in the BaZi chart, and the Ganzhi Karma Structure Diagram (GKSD) constructed based on this method.

### BACKGROUND TECHNOLOGY

Chinese traditional astrology has thousands of years of history, based on the theory of Yin-Yang, Five Elements and Ganzhi system, predicting the development patterns of people and things by analyzing the BaZi (Heavenly Stems and Earthly Branches of year, month, day, and hour four pillars). Traditional astrological analysis mainly relies on text symbols and oral teaching, lacking a standardized visual expression method.

In traditional astrology, Earthly Branches are viewed as compounds containing multiple Stored Stems. For example, Yin Wood contains three types of Five Elements energy: Jia Wood, Bing Fire, and Wu Earth. The interrelationships between these Stored Stems and other elements in BaZi are often described with abstract astrological terminology, making it difficult to precisely define the contents involved in the relationships.

Currently, astrological analysis is mainly conducted through text tables and descriptions. Analysts' understanding and interpretation of specific charts often differ due to personal experience and school differences. The lack of intuitive graphical expression tools creates barriers to the inheritance of astrological knowledge and cross-cultural communication.

### COMPARISON WITH EXISTING TECHNOLOGY

Traditional astrological analysis methods mainly have the following limitations:

Due to the lack of punctuation marks in ancient China and the late introduction of mathematical and logical concepts, traditional astrological relationship descriptions are vague, lacking directionality and quantitative cognition. For example, “Water controls Fire” sounds like a one-way relationship in traditional description, but it is actually bidirectional: when there is enough fire, it can counter-control water.

Cross-language communication barriers: Traditional astrology relies on Chinese symbols and terminology, making cross-cultural and cross-language communication extremely difficult. Non-Chinese speakers find it difficult to accurately understand and apply these concepts. The GKSD diagram of this invention, as a symbol universal language, overcomes language barriers by replacing text descriptions with visualized graphic symbols, enabling people with different language backgrounds to understand and communicate astrological concepts, greatly promoting the internationalization of astrology.

The traditional Five Elements system only defines two basic relationships: “generate” and “control,” unable to precisely express complex interactions between elements. The GKSD relationship system of this invention refines Five Elements relationships into 8 types and expands Ganzhi relationships from the traditional 5 to 12 types (500-511), and adds 7 types of status icons (600-602, 700-703), greatly improving the precision of analysis.

In existing astrological analysis, different Stored Stems within the same Earthly Branch actually have different states, with some Stored Stems increasing in energy and others decreasing when relationships occur, but there is a lack of intuitive expression. This invention introduces Stored Stem status markers that can clearly show the specific state changes of Stored Stems under various relationship influences.

For abstract descriptions of changes, traditional astrological terms are difficult to quantify. The GKSD system visualizes these abstract concepts, such as using specific icons to represent “integrity change” (Penetration), “restrained but integrity unchanged” (Combination), “active mobility” (Clash) and “although mutually controlling, these elements abnormally do not interfere with each other and integrity is not affected” (Cut), etc.

Traditional astrology usually treats multiple Stored Stems in a single Earthly Branch as a whole, unable to express the independent state of each Stored Stem. The GKSD diagram rearranges Stored Stems according to their Ten Gods relationship with the Day Master, making the individual characteristics of each Stored Stem clearly visible.

Traditional astrology does not distinguish between different Earthly Branch natures in the same relationship. For example, Zi-Wu clash is integrity damage for normal Earthly Branches, but opening the gate for Repository Earthly Branches. The GKSD diagram distinguishes these different reaction patterns and their effects on Stored Stems through special icons.

Existing astrological charts lack spatial structural hierarchy, while the GKSD diagram adopts an inner and outer circle design, with Heavenly Stems elements in the inner circle representing the main structure, and Earthly Branches elements in the outer circle representing the supporting structure, making the chart hierarchy at a glance.

Traditional Five Elements energy flow usually only considers clockwise generating relationships, while the GKSD diagram considers potential priority reactions that may cross traditional generating sequence, more in line with complex situations in astrological analysis.

Therefore, the GKSD diagram method of this invention solves the fundamental problems of vague expression, unclear directionality, and lack of quantification in traditional astrological analysis through refined relationship definitions and systematic graphic language, providing an unprecedented precise analysis tool for astrology.

### INVENTION CONTENT

The purpose of this invention is to provide a multi-dimensional symbol mapping system and method for Ganzhi energy relationship research, solving problems such as vague expression, lack of standardization and visualization in traditional astrological analysis, and realizing precise expression and inheritance of astrological knowledge.

The technical solution provided by this invention is a method for transforming Four Pillars BaZi Heavenly Stems and Earthly Branches elements and their relationships into standardized graphics, which includes the following key steps:
1. Establishing a standardized symbol system: including Five Elements symbols, Heavenly Stems and Earthly Branches symbols, Ten Gods relationship symbols and status icons, with each symbol having clearly defined visual characteristics;
2. Traditional BaZi chart transcription: transcribing traditional Four Pillars BaZi chart information using Ten Gods icons for relationship transcription;
3. Relationship identification and annotation: identifying and annotating relationships between Heavenly Stems and Earthly Branches according to GKSD relationship definitions;
4. Graphical layout construction: placing Heavenly Stems elements in the inner circle and Stored Stems of Earthly Branches in the outer circle, constructing a GKSD diagram with hierarchical structure;
5. Establishing Stored Stem relationships: establishing connecting relationships between Stored Stems elements according to Ganzhi relationship rules;
6. Confirming element status: adding status icons to relevant elements according to relationship effects, indicating the current status of elements.

In addition, this invention innovatively proposes the following technical features:
1. Refining vague relationship descriptions in traditional astrology into 12 clearly defined Ganzhi relationships (500-511), making relationship expressions more precise;
2. Designing element layout rules based on ICMPE five regions, placing elements with similar functions together for an overall grasp of chart characteristics;
3. Introducing a status icon system to represent element state changes under various relationship effects, such as opening repository, closing repository, rising, falling, etc.

Through the above technical solutions, this invention achieves the following beneficial effects:
1. Realizing standardized expression of astrological concepts, solving the problems of vague expression and lack of quantification in traditional astrology;
2. Overcoming language barriers by replacing text descriptions with a visualized symbol system, promoting cross-language communication and internationalization of astrology;
3. Improving the precision and consistency of astrological analysis through refined and standardized relationship definitions;
4. Introducing Stored Stem status markers that clearly show the specific state changes of Stored Stems under various relationship influences;
5. Adopting inner and outer circle hierarchical structure design, making chart hierarchy clear at a glance, facilitating overall grasp of chart characteristics.

### SPECIFIC IMPLEMENTATION METHOD

### Symbol Application Range and Function

The GKSD diagram method of the invention uses a series of standardized icon symbols, with each type of symbol having a specific application range and function. The hierarchical structure and application relationship of the icon system are as follows:

### Five Elements and Relationship Symbol System

### Five Elements Symbols

Fire (100)
Wood (101)
Water (102)
Metal (103)
Earth (104)

### Five Elements Relationship Symbols

Outflow (200): Energy is drained out, used to generate other elements
Generate (201): A relationship where one element produces or nourishes another element
Receive Support (202): A relationship where one element is produced or nourished by another element
Control Outflow (203): One element actively inhibits another element
Control (204): A relationship where one element inhibits another element
Be Controlled (205): A relationship where one element is inhibited or controlled by another element
Root Link Symbol (206): Indicates a Five Elements element receives support from other positions
Same Element (207): The relationship between two identical elements

### Strength Representation

FIG. 7 Metal (103) Control (203) Wood (101): Indicates Metal is strong, Wood is controlled
FIG. 7 Metal (103) Be Controlled (205) Wood (101): Indicates Wood is strong, counter-controls Metal

### Ganzhi Elements and Relationship Symbol System

### Heavenly Stems

Jia (300): Yang Wood element
Yi (301): Yin Wood element
Bing (302): Yang Fire element
Ding (303): Yin Fire element
Wu (304): Yang Earth element
Ji (305): Yin Earth element
Geng (306): Yang Metal element
Xin (307): Yin Metal element
Ren (308): Yang Water element
Gui (309): Yin Water element

### Earthly Branches

Zi (400): Contains Stored Stem Gui (309)
Chou (401): Repository, stores stronger energy than regular elements, difficult to damage; contains Stored Stems Ji (305), Gui (309), Xin (307)
Yin (402): Contains Stored Stems Jia (300), Bing (302), Wu (304)
Mao (403): Contains Stored Stem Yi (301)
Chen (404): Repository, stores stronger energy than regular elements, difficult to damage; contains Stored Stems Wu (304), Yi (301), Gui (309)
Si (405): Contains Stored Stems Bing (302), Geng (306), Wu (304)
Wu (406): Contains Stored Stems Ding (303), Ji (305)
Wei (407): Repository, stores stronger energy than regular elements, difficult to damage; contains Stored Stems Ji (305), Ding (303), Yi (301)
Shen (408): Contains Stored Stems Geng (306), Ren (308), Wu (304)
You (409): Contains Stored Stem Xin (307)
Xu (410): Repository, stores stronger energy than regular elements, difficult to damage; contains Stored Stems Wu (304), Xin (307), Ding (303)
Hai (411): Contains Stored Stems Ren (308), Jia (300)

### Ganzhi Relationship Symbols

Three Harmony (500): Three Earthly Branches merge into a great force
Half Harmony (501): ⅔ conditions of Three Harmony are met, 2 energies merge into one force
Harmony with Storage (502): ⅔ conditions of Three Harmony are met, and one participant is a Repository
Break (503): Indicates two elements with slight damage
Clash (504): Indicates two elements with increased dynamic nature and accompanying damage
Cut (505): Represents two elements not reacting, although their Five Elements are mutually controlling
Combination (506): Represents two elements mutually attracting, maintaining integrity, although their Five Elements are mutually controlling
Six Combination (507): Specific Ganzhi combination relationship
Hidden Combination (508): Indicates two elements secretly attracting each other
Temporary Hidden Combination (509): Indicates two elements secretly attracting each other, but for a short time, soon separating
Three Meeting (510): Indicates 3 elements merging into one force due to consistent direction
Penetration (511): Indicates 2 elements quickly harming each other, and the harm is unstoppable

### Status Icons

Three Punishment (600): Indicates Repository being worn and damaged
Opening Repository (601): The lid of the Repository is opened
Closing Repository (602): The lid of the Repository is closed
Falling (700): Indicates energy decreasing
Rising (701): Indicates energy increasing
Energy Enhancement (702): Formed by fixed pairing of Heavenly Stem and Earthly Branch in the same pillar. Indicates the upper element has abnormally large energy
Damage (703): Indicates energy is limited, damaged

### Ten Gods Relationship System

FIG. 10a Ten Gods relationships are the relative Five Elements Yin-Yang relationships between Heavenly Stems and Stored Stems in Earthly Branches with the Day Master (1300). The arrangement rules of Ten Gods relationships are fixed rules in traditional astrology.

### Ten Gods Icons

FIG. 4 Icon (800) Windfall (WF): Has a Be Controlled (205) relationship with the Day Master, with Same Polarity
FIG. 4 Icon (801) Wealth (WE): Has a Be Controlled (205) relationship with the Day Master, with Opposite Polarity
FIG. 4 Icon (802) Twin (TW): Has a Same Element (207) relationship with the Day Master, with Same Polarity
FIG. 4 Icon (803) Plunder (PL): Has a Same Element (207) relationship with the Day Master, with Opposite Polarity
FIG. 4 Icon (804) Crest (RE): Has an Outflow (200) relationship with the Day Master, with Same Polarity
FIG. 4 Icon (805) Seal (SE): Has an Outflow (200) relationship with the Day Master, with Opposite Polarity
FIG. 4 Icon (806) Epicure (EP): Has a Receive Support (202) relationship with the Day Master, with Same Polarity
FIG. 4 Icon (807) Maverick (MV): Has a Receive Support (202) relationship with the Day Master, with Opposite Polarity
FIG. 4 Icon (808) Crown (CR): Has a Control Outflow (203) relationship with the Day Master, with Opposite Polarity
FIG. 4 Icon (809) Amok (OK): Has a Control Outflow (203) relationship with the Day Master, with Same Polarity

### Case Analysis

This section explains the practical application of the GKSD method and how to handle common relationships between Ganzhi elements through a series of cases. This article only lists some representative cases, and more complex relationship combinations may appear in practical applications.

### Five Elements Relationship Cases

FIG. 7 Fire (100) Generate (201) Earth (104): Fire generates Earth relationship
FIG. 7 Water (102) Outflow (200): Water's energy is drained out
FIG. 7 Wood (101) Receive Support (202): Wood is generated by other elements
FIG. 7 Metal (103) Control (204) Wood (101): Metal controls Wood relationship
FIG. 7 Metal (103) Same Element (207) Metal (103): Same element relationship between two Metal elements
FIG. 7 Metal (103) Control (203) Wood (101): Indicates Metal is strong, Wood is controlled
FIG. 7 Metal (103) Be Controlled (205) Wood (101): Indicates Wood is strong, counter-controls Metal

### Ganzhi Relationship Cases

FIG. 8a Shen (408) Zi (400) Chen (404) Three Harmony (500): Three Earthly Branches merge into a great force, adding Rising (701) status icon to the middle element, Chen (404) as a Repository, adding Falling (700) status icon, remaining elements adding Falling (700) status icon.
FIG. 8a Shen (408) Zi (400) Half Harmony (501): Adding Rising (701) status icon, ⅔ conditions of Three Harmony are met, 2 energies merge into one force, remaining elements adding Falling (700) status icon.
FIG. 8a Shen (408) Chen (404) Harmony with Storage (502): ⅔ conditions of Three Harmony are met, Chen (404) is a Repository, the lid is opened, adding Opening Repository (601) status icon.
FIG. 8a Mao (403) Break (503) Wu (406): Indicates These 2 Elements Have Slight Damage.
FIG. 8a Zi (400) Clash (504) Wu (406): Indicates these 2 elements have increased dynamic nature and accompanying damage, the element with less energy adds Damage (703) icon.
FIG. 8a Chen (404) Clash (504) Xu (410): Since these 2 elements are Repositories, the lids are damaged, Repositories open, adding Opening Repository (601) status icon to both elements. Anchoring these 2 elements to the GKSD diagram FIG. 9a, for example: when Day Master is Jia (300), status icon (601) is added to the first Stored Stem in the Earthly Branch, representing the lid being opened.
FIG. 8a Yin (402) Cut (505) You (409): Represents these two elements not reacting, although their Five Elements are mutually controlling.
FIG. 8a Wu (304) Combination (506) Gui (309): Represents these two elements mutually attracting, maintaining integrity, although Five Elements are mutually controlling.
FIG. 8a Yin (402) Six Combination (507) Hai (411): GKSD system specifies, Stored Stem Ren (308) in Hai (411) Generate (201) Stored Stem Jia (300) in Yin (402); Stored Stem Ren (308) in Hai (411) Control (204) Stored Stem Bing (302) in Yin (402). Anchoring these 2 elements to the GKSD diagram FIG. 9b, for example: when Day Master is Jia (300).
FIG. 8a Mao (403) Six Combination (506) Xu (410): Xu (410) is a Repository, adding Closing Repository (602) status icon. Anchoring these 2 elements to the GKSD diagram FIG. 9c, for example: when Day Master is Jia (300), status icon (602) is added to the first Stored Stem in the Earthly Branch, representing the lid being closed. As closing repository is not a continuous action, no connecting line is added.
FIG. 8b Chou (401) Wei (407) Xu (410) Three Punishment (600): These three elements are all Repositories, adding Three Punishment (600) status icon to each element, indicating Repositories being worn and damaged.
FIG. 8b Yin (402) Hidden Combination (508) Chou (401): Indicates these 2 elements secretly attracting each other, not visible on the surface. Although Chou (401) is a Repository, this relationship has no effect on the Repository, no status icon is added. Anchoring these 2 elements to the GKSD diagram FIG. 9d, for example: when Day Master is Jia (300). GKSD defines in this relationship, Stored Stems Jia (300), Bing (302), Wu (304) in Yin and Stored Stems Ji (305), Gui (309), Xin (307) in Chou (401), having Combination (506) relationships in pairs.
FIG. 8b Wu (406) Temporary Hidden Combination (509) Hai (411): Indicates these 2 elements secretly attracting each other, but for a short time, soon separating. GKSD defines in this relationship, Stored Stems Ding (303), Ji (305) in Wu (406), and Stored Stems Ren (308), Jia (300) in Hai (411), having Combination (506) relationships in pairs.
FIG. 8b Yin (402) Mao (403) Chen (404) Three Meeting (510): Indicates 3 Elements Merging Into one force due to consistent direction.
FIG. 8b Shen (408) Penetration (511) Hai (411): Indicates 2 elements quickly harming each other, and the harm is unstoppable. GKSD defines Stored Stem Geng (306) in Shen Penetration (511) Stored Stem Jia (300) in Hai (411). When mapping to GKSD FIG. 9e, adding Damage (703) icon to affected Stored Stems, for example: when Day Master is Jia (300).
FIG. 8b Zi (400) Control (204) Xu (410): Indicates 2 elements are mutually controlling due to their Stored Stems' Five Elements attributes. GKSD defines Stored Stem Gui (309) in Zi (400) Control (204) Stored Stem Ding (303) in Xu (401). When mapping to GKSD, since the influence is minimal, no connecting line is connected. Damage (703) icon is only added to affected Stored Stems.
FIG. 8b Ren (308) above, Chen (404) below in the same pillar: Using Energy Enhancement (702) to indicate the upper element has abnormally large energy. When mapping to GKSD FIG. 9f, adding status icon (702) to the upper element Ren, for example: when Day Master is Jia (300).

### Now Beginning the Introduction of Placement Board Elements

### Placement Board has ICMPE Five Regions FIG. 5

ICMPE five regions are GKSD diagram's functional classification of Ten Gods relationships, with each region representing different types of energy and functions in the chart:

### I (i Am): Self-identification Region, for Placing

Twin (TW): Same Five Elements attribute and Same Polarity as the Day Master, can enhance Day Master's energy
Plunder (PL): Same Five Elements attribute but Opposite Polarity as the Day Master, will disperse Day Master's energy

### C (Capacity): Capability Region, for Placing

Maverick (MV): Radical energy flowing from the Day Master, representing creativity and change
Epicure (EP): Gentle energy flowing from the Day Master, representing enjoyment and quality of life

### M (Money): Wealth Region, for Placing

Windfall (WF): Unstable source of wealth, such as investments, speculation, etc.
Wealth (WE): Stable source of wealth, such as work income, fixed assets, etc.

### P (Power): Power Region, for Placing

Crown (CR): Managerial power, representing rules and order
Amok (OK): Fierce force, representing competition and pressure

### E (Entitlement): Rights Region, for Placing

Seal (SE): Rights consolidated based on contracts, representing tradition and protection
Crest (RE): Alternative rights, representing knowledge and observation

There are default energy flow paths between ICMPE regions: I→C→M→P→E→I, forming a complete energy circulation system. This layout principle places functionally similar elements together in the GKSD diagram, facilitating overall grasp of chart characteristics and energy distribution.

It should be noted that Heavenly Stems are pure material elements, while Earthly Branches are compounds composed of 1-3 Heavenly Stem elements, a concept similar to the relationship between elements and compounds in chemistry. In the GKSD diagram, Heavenly Stem elements are in the inner circle, representing the main structure; Stored Stems in Earthly Branches are in the outer circle, representing the supporting structure, forming a complete chart hierarchical system.

Heavenly Stem pieces have 5 variants, the fan-shaped shadow part indicates this element comes from the position in the traditional BaZi chart FIG. 10a
FIG. 6a 1100: From the first column, Year Pillar
FIG. 6 1100a: From the second column, Month Pillar
FIG. 6a 1100b: From the third column, Day Pillar
FIG. 6a 1100c: From the fourth column, Hour Pillar
FIG. 6a 1100d: From any column (fan-shaped shadow can be changed according to requirements), with status icon

Stored Stem pieces of Earthly Branches have 5 variants, the triangular shadow part indicates this element comes from the position in the traditional BaZi chart FIG. 10a

Earthly Branch piece's top right corner blank space can place Earthly Branch icon (400-411), indicating which Earthly Branch this Stored Stem comes from.
FIG. 6b 1200: From the first column, Year Pillar
FIG. 6 1200a: From the second column, Month Pillar
FIG. 6b 1200b: From the third column, Day Pillar
FIG. 6b 1200c: From the fourth column, Hour Pillar
FIG. 6b 1200d: From any column (triangular shadow can be changed according to requirements), with status icon

### Complete Four Pillars BaZi Analysis Process Based on GKSD Method

Assume someone's Four Pillars BaZi is: Year Pillar: Xin (307) Si (405) Month Pillar: Ding (303) You (409) Day Pillar: Geng (306) Chen (404) (Day Master is Geng) Hour Pillar: Ji (305) Mao (403)

### Step One: Traditional Four Pillars BaZi Chart

First, arrange the Four Pillars BaZi chart in the traditional way, as shown in FIG. 10a, where Day Master position 1300 is Day Master Geng (306).

### Step Two: Ten Gods Relationship Transcription

Using the GKSD Ten Gods icon system, transcribe according to the relationship of each element with Day Master Geng Metal:
Year Pillar Heavenly Stem Xin Metal: Plunder (803)
Year Pillar Earthly Branch Si Fire Stored Stems: Wu as Crest (804), Geng as Twin (802), Bing as Amok (809)
Month Pillar Heavenly Stem Ding Fire: Crown (808)
Month Pillar Earthly Branch You Metal Stored Stem: Xin Metal as Plunder (803)
Day Pillar Heavenly Stem Geng Metal: Day Master (1300)
Day Pillar Earthly Branch Chen Earth Stored Stems: Wu Earth as Crest (804), Yi Wood as Wealth (801), Gui Water as Maverick (807)
Hour Pillar Heavenly Stem Ji Earth: Seal (804)
Hour Pillar Earthly Branch Mao Wood Stored Stem: Yi Wood as Wealth (801)

Transcription results are shown in FIG. 10b.

### Step Three: Relationship Identification and Annotation

According to GKSD relationship definitions, identify and annotate the following relationships:
1. Heavenly Stems Xin (307) and Ding (303) are mutually controlling, annotated as Control (204)
2. Heavenly Stems Ding (303) and Geng (306) are mutually controlling, annotated as Control (204)
3. Heavenly Stem Ji (305) energy drains out to generate Xin (307), annotated as Outflow (200)
4. Heavenly Stem Ji (305) energy drains out to generate Geng (306), annotated as Outflow (200)
5. Heavenly Stem Ding (303) energy drains out to generate Ji (305), annotated as Outflow (200)
6. Earthly Branches Si (405) You (409) Half Harmony (501), forming one force
7. Earthly Branches Mao (403) You (409) Clash (504), annotated as Mao Wood damaged (703)
8. Earthly Branches Mao (403) Chen (404) Penetration (511), annotated as Mao Wood severely damaged (703)
9. Earthly Branches Chen (404) You (409) Six Combination (507), according to GKSD definition, this relationship causes Repository Chen (404) to be closed, adding Closing Repository (602) status icon
10. Heavenly Stem Xin (307) and Bing (302) in Si (405) Combination (506), indicating two elements mutually attracting, maintaining integrity
11. Day Master Geng (306) and Chen (404) form Energy Enhancement (702) pairing, Geng gets greatly enhanced energy, adding Energy Enhancement (702) status icon

Annotation results are shown in FIG. 10c.

### Step Four: GKSD Diagram Layout

According to GKSD placement rules, place each element in the corresponding position:

### Inner Circle Elements

I Region (Self-Identification):
Day Master Geng (306)
Plunder (803) Xin (307) from Year Pillar

C Region (Capacity):
(No inner circle elements)

M Region (Money):
(No inner circle elements)

P Region (Power):
Crown (808) Ding (303)

E Region (Entitlement):
Seal (805) Ji (305)

Outer Circle Elements:

I Region (Self-Identification):
Twin (802) Geng (306) from Year Pillar Si (405)
Plunder (803) Xin (307) from Month Pillar You (409)

C Region (Capacity):
Maverick (807) Gui (309) from Day Pillar Chen (404)

M Region (Money):
Wealth (801) Yi (301) from Hour Pillar Mao (403)
Wealth (801) Yi (301) from Day Pillar Chen (404)

P Region (Power):
Amok (809) Bing (302) from Year Pillar Si (405)

E Region (Entitlement):
Crest (804) Wu (304) from Year Pillar Si (405)
Crest (804) Wu (304) from Day Pillar Chen (404)

This organization clearly distinguishes between the inner circle (primary Heavenly Stem elements) and the outer circle (Stored Stems from specific Earthly Branches).

Placement results are shown in FIG. 11a.

### Step Five: Establishing Stored Stem Relationships

According to relationships identified in Step Three, establish connecting lines between elements:
1. Yi (301) from Mao (403) connects to Xin (307) from You (409), as Clash (504)
2. Yi (301) from Chen (404) connects to Xin (307) from You (409), as Six Combination (507)
3. Bing (302) from Si (405) connects to Heavenly Stem Xin (307), as Combination (506)
4. Xin (307) and Ding (303) as Control (204)
5. Ding (303) and Geng (306) as Control (204)
6. Ding (303) and Ji (305), as Generate (201)
7. Ji (305) and Xin (307), as Generate (201)
8. Ji (305) and Geng (306) as Generate (201)
9. Wu (304) from Chen (404) gives power to Geng (306), forming Energy Enhancement (702)
10. Wu (304) from Chen (404) and Xin (307), Xin closed Chen, adding connecting line with no icon

Connection results are shown in FIG. 11b.

### Step Six: Confirming Stored Stem Status

According to relationship effects, mark status for each element:
1. Yi Wood (301) in Mao (403), marked as Be Controlled (703)
2. Yi Wood (301) in Chen (404), because GKSD defines Chen-You Six Combination damages Yi, marked as Be Controlled (703)
3. Bing (302) in Si (405), because GKSD defines Si-You Half Harmony, Fire energy decreases, Metal energy increases, Bing is Fire, marked as Falling (700)
4. Geng (306) in Si (405) combines with Xin (307) in You (409), because GKSD defines Si (405)-You (409) Half Harmony, Fire energy decreases, Metal energy increases, Geng (306) is Metal, marked as Rising (701)
5. Wu (304) in Chen (404), because GKSD defines Chen (404)-You (409) Six Combination, closing Repository Chen, and Wu (304) is the first Stored Stem in Chen (404), adding Closing Repository (602) icon

Final GKSD diagram results are shown in FIG. 11c.
1. In this chart, Heavenly Stem elements mainly present the interaction relationship between Metal and Fire Five Elements
2. At the Earthly Branches level, it shows a state of Metal and Wood confrontation
3. Repository Chen Earth is closed, energy cannot flow effectively
4. Day Master forms multiple relationship connections with other elements

This GKSD graphical expression makes the element relationship structure of the chart clear at a glance. Through standardized symbols and connection relationships, the mutual influences and state changes between elements can be clearly seen, providing a visualization basis for subsequent in-depth analysis. With this method, analysts can quickly identify structural patterns in charts without relying on traditional text descriptions, greatly improving analysis efficiency and consistency.

### DESCRIPTION OF FIGURES

FIG. 1 Five Elements, Five Elements relationship icons and Heavenly Stems Chinese characters

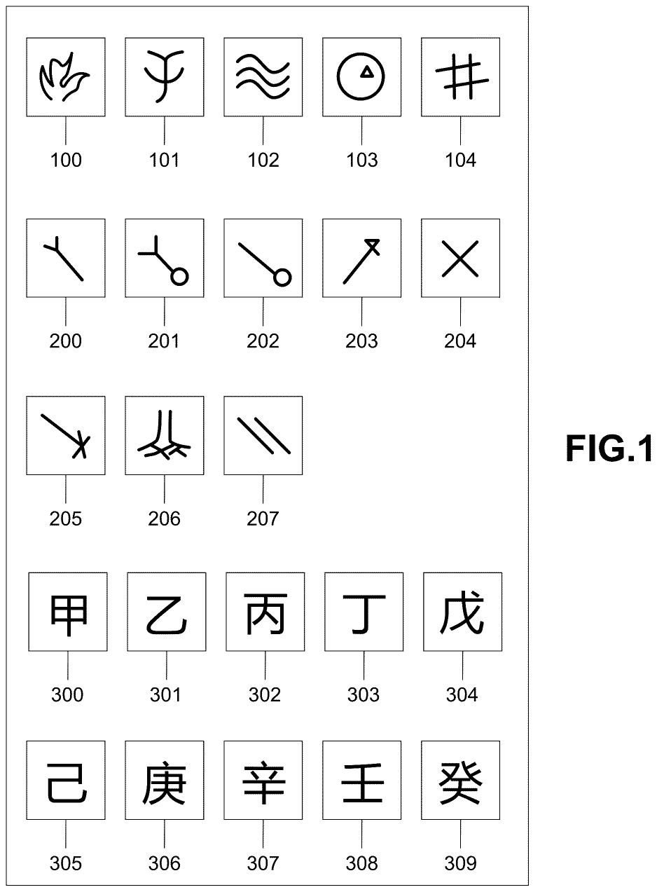

FIG. 2 Earthly Branches Chinese characters

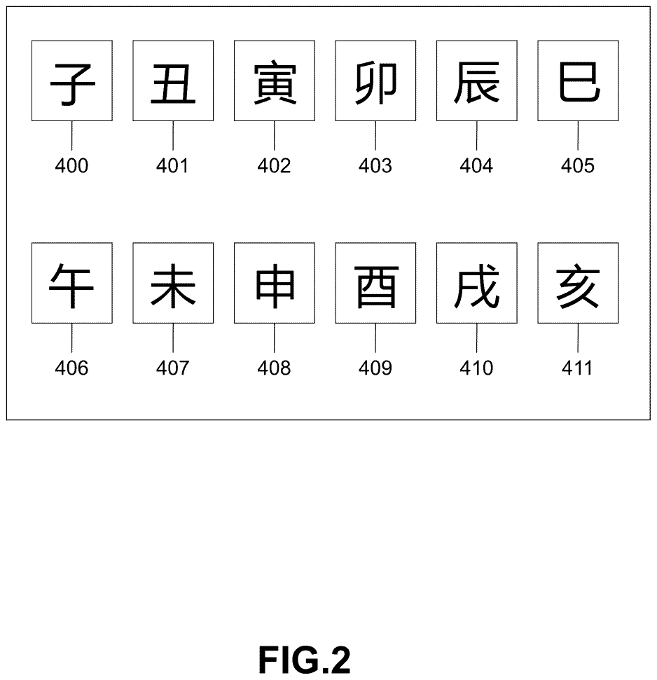

FIG. 3 Ganzhi relationship, Ganzhi status icons

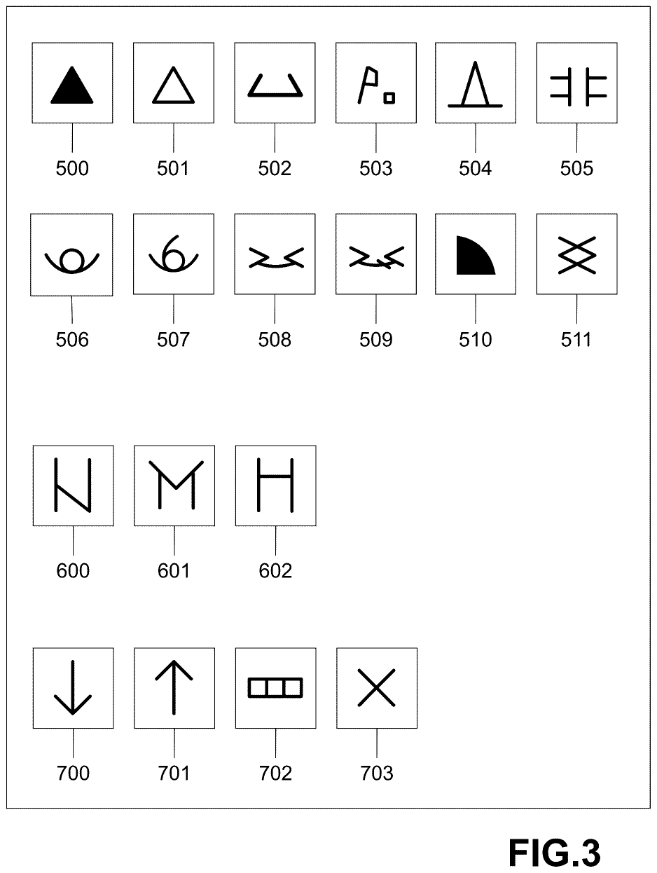

FIG. 4 Ten Gods icons

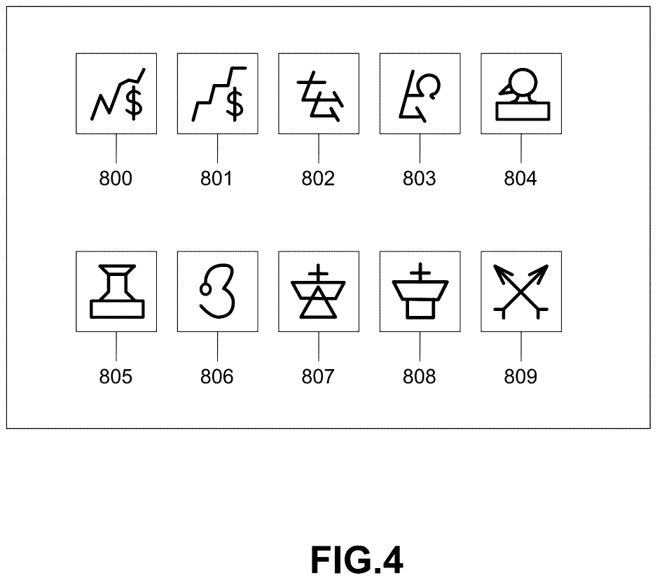

FIG. 5 GKSD placement board

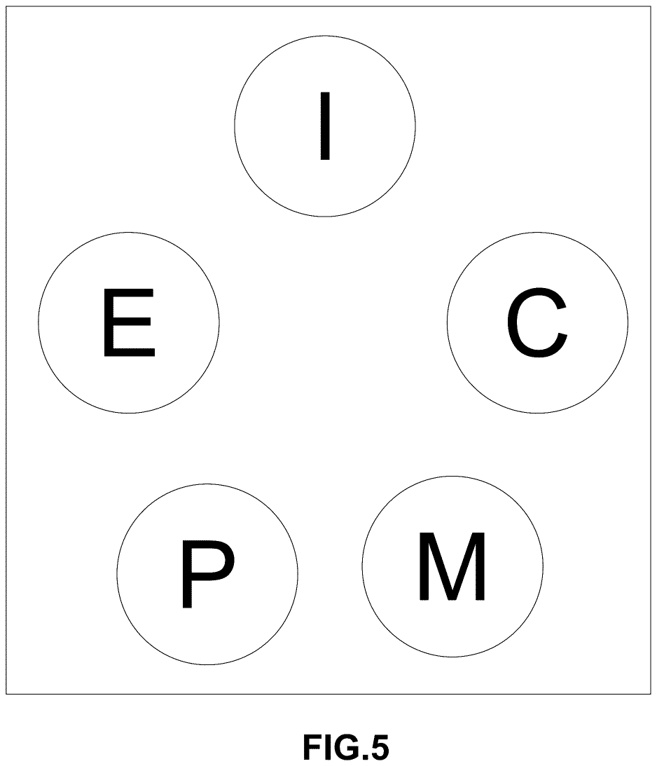

FIG. 6a GKSD Heavenly Stem elements and their variable expressions

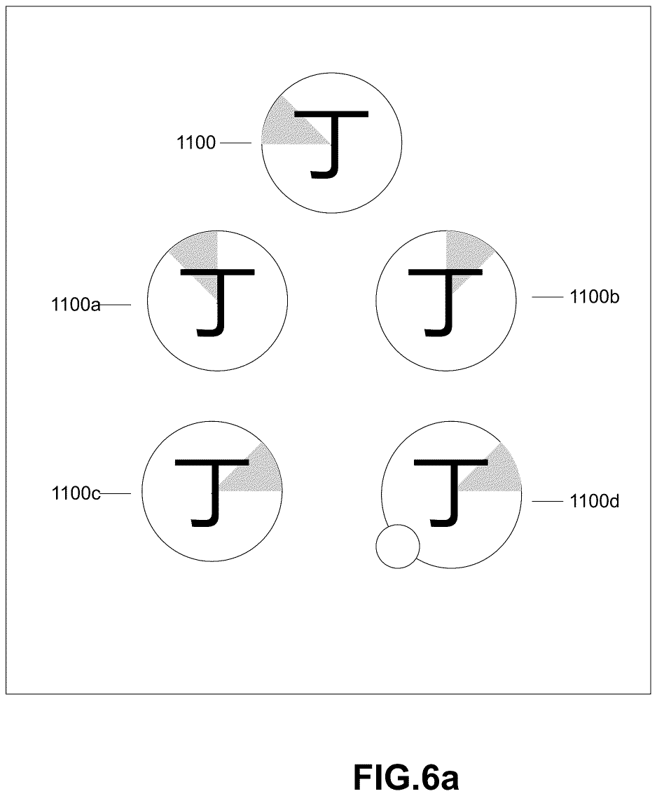

FIG. 6b GKSD Earthly Branch elements and their variable expressions

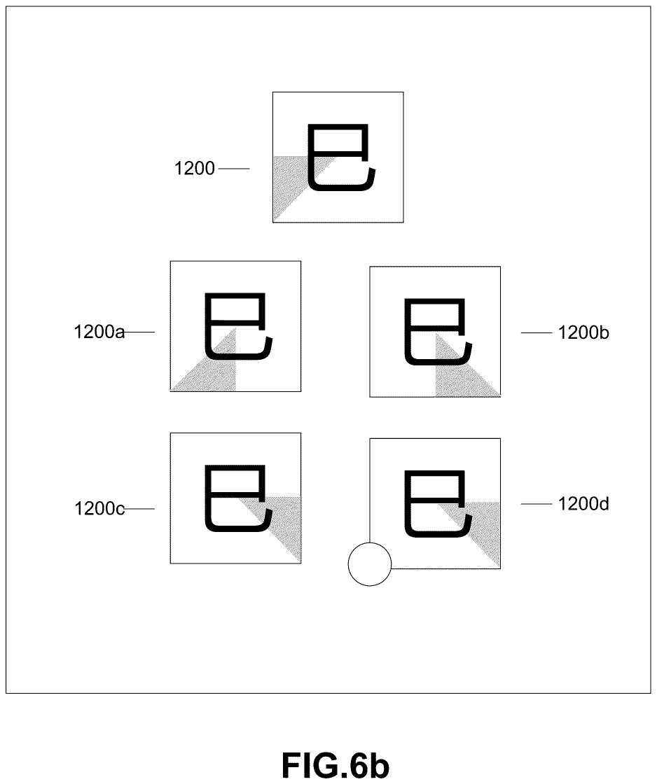

FIG. 7 Using Five Elements relationship icons to represent Five Elements relationships

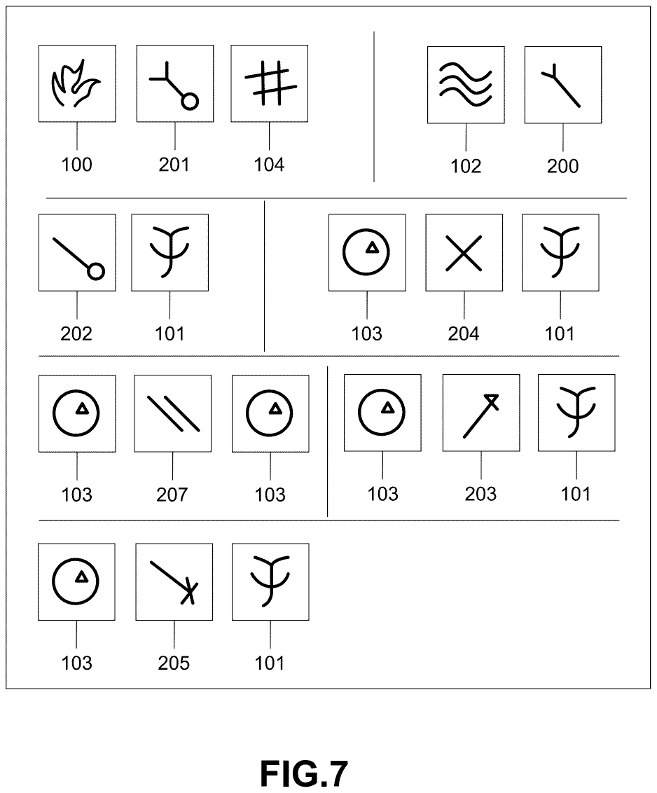

FIG. 8a Using Ganzhi relationship and Ganzhi status icons to represent Ganzhi relationships

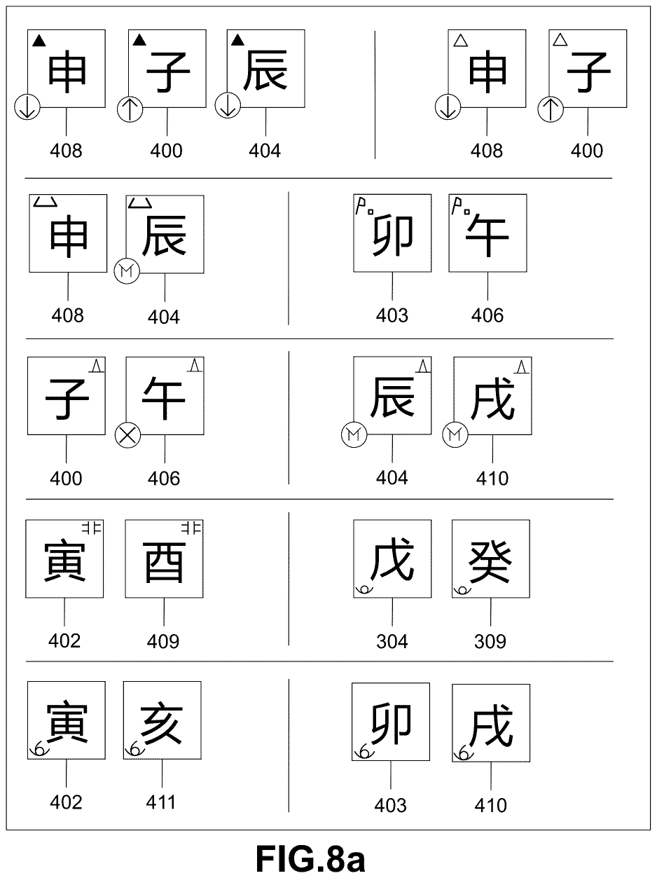

FIG. 8b Using Ganzhi relationship and Ganzhi status icons to represent Ganzhi relationships

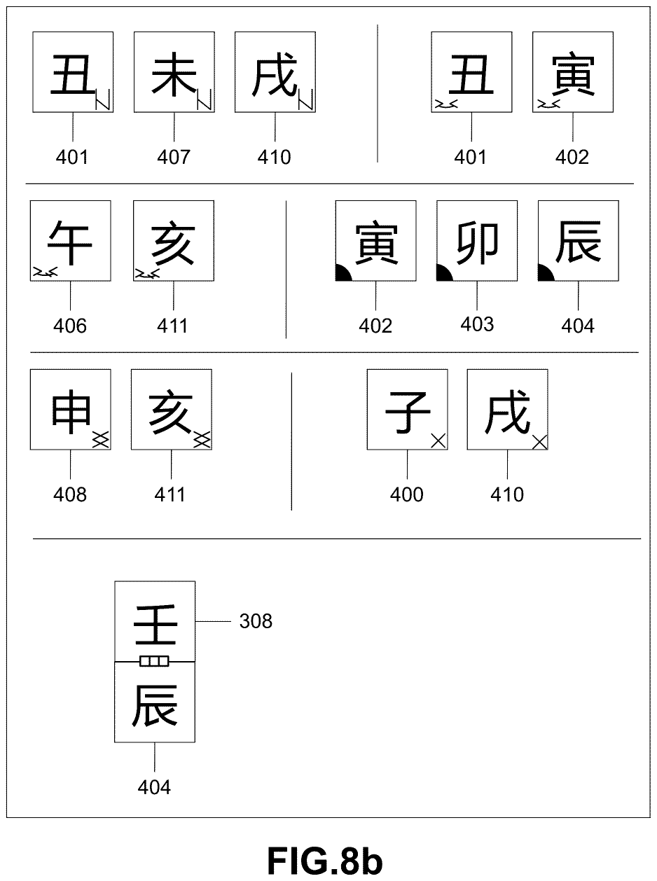

FIG. 9a Anchoring identified Chen (404) and Xu (410) Ganzhi relationship icons to the GKSD diagram

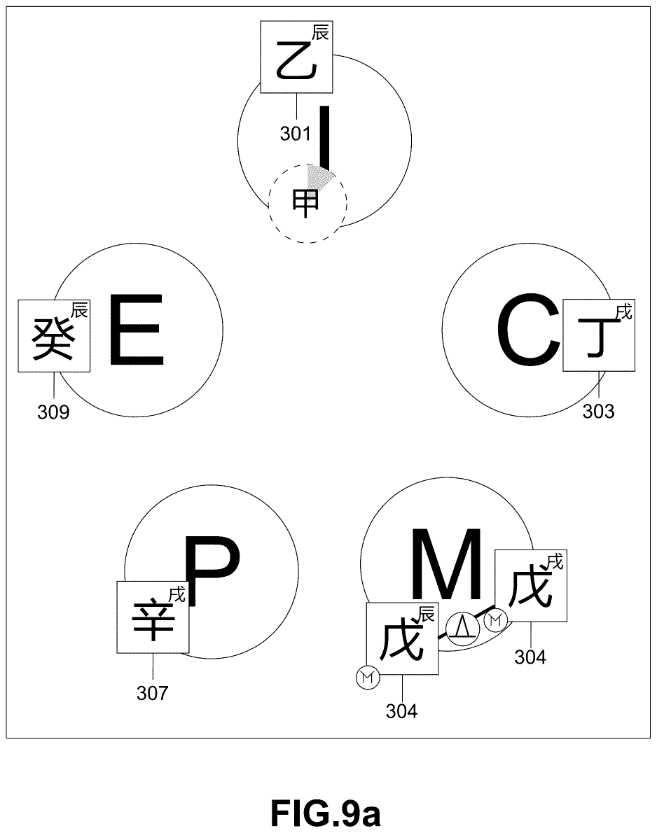

FIG. 9b Anchoring identified Yin (402) and Hai (411) Ganzhi relationship icons to the GKSD diagram

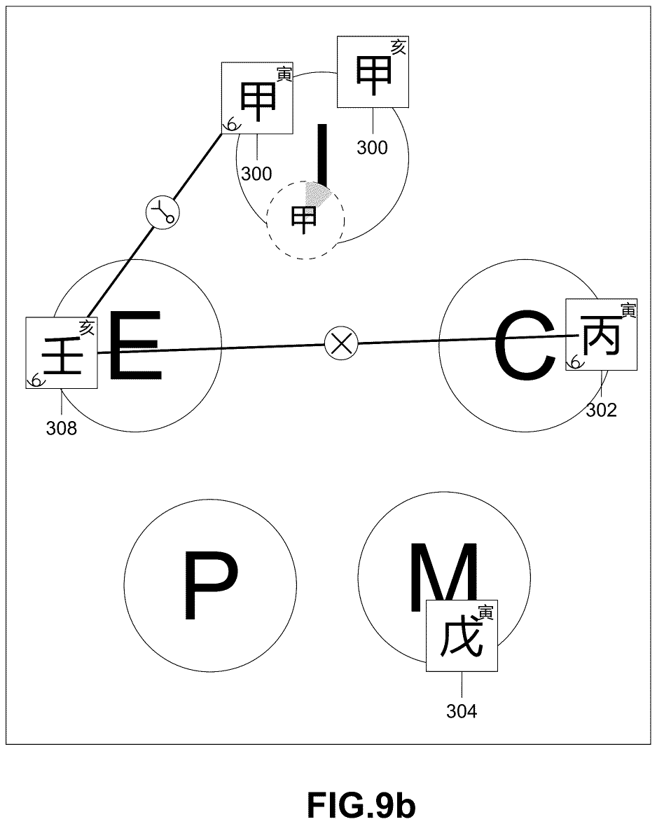

FIG. 9c Anchoring identified Mao (403) and Xu (410) Ganzhi relationship icons to the GKSD diagram

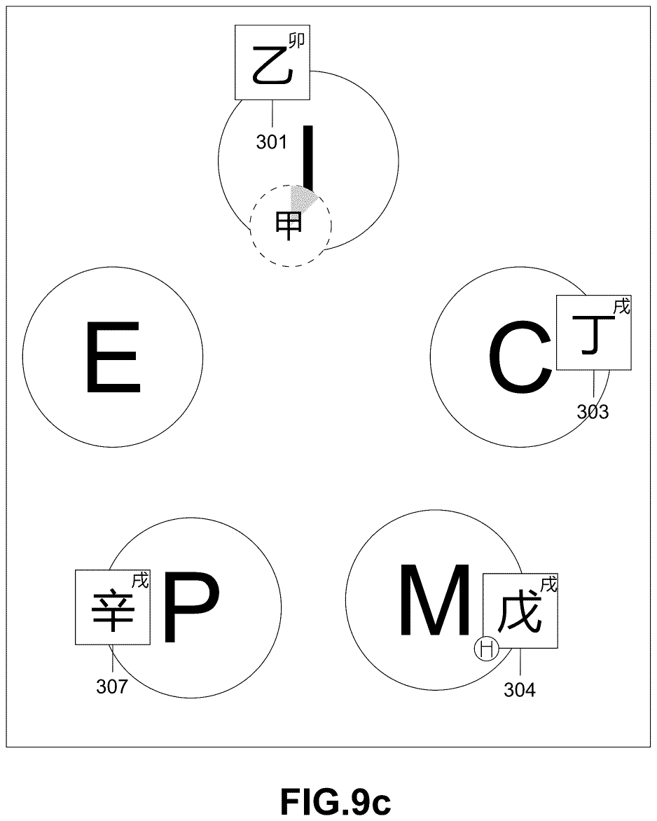

FIG. 9d Anchoring identified Yin (402) and Chou (401) Ganzhi relationship icons to the GKSD diagram

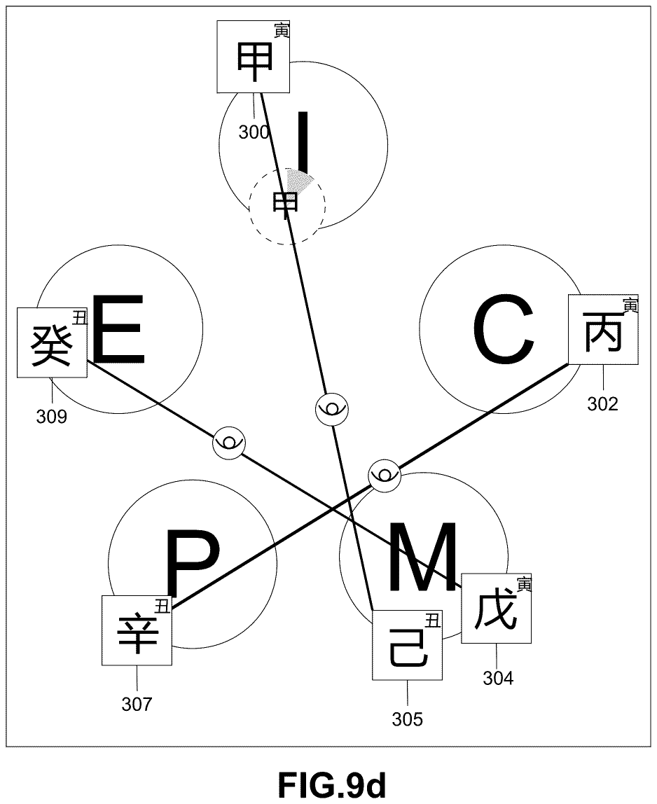

FIG. 9e Anchoring identified Shen (408) and Hai (411) Ganzhi relationship icons to the GKSD diagram

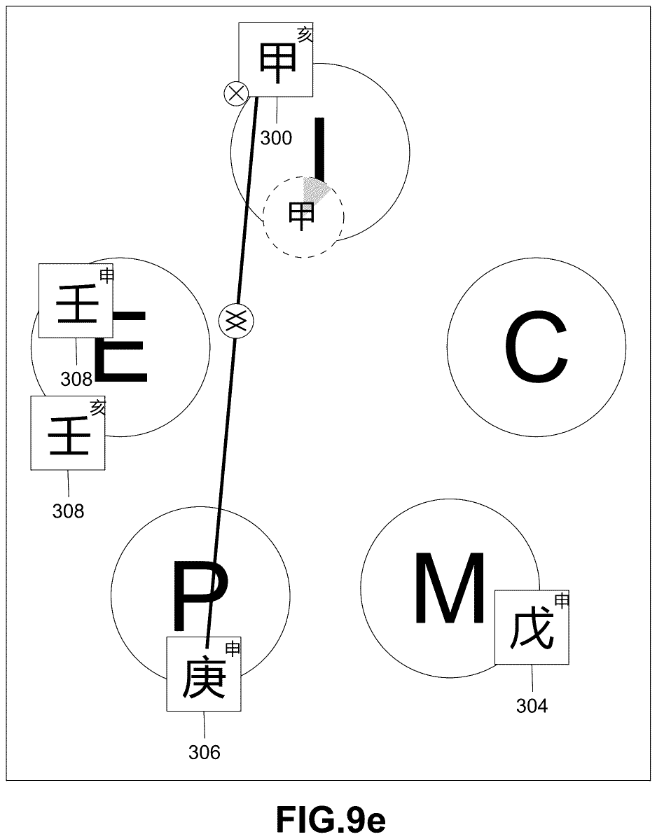

FIG. 9f Anchoring identified Ren (308) and Chen (404) same pillar upper-lower Ganzhi relationship icons to the GKSD diagram

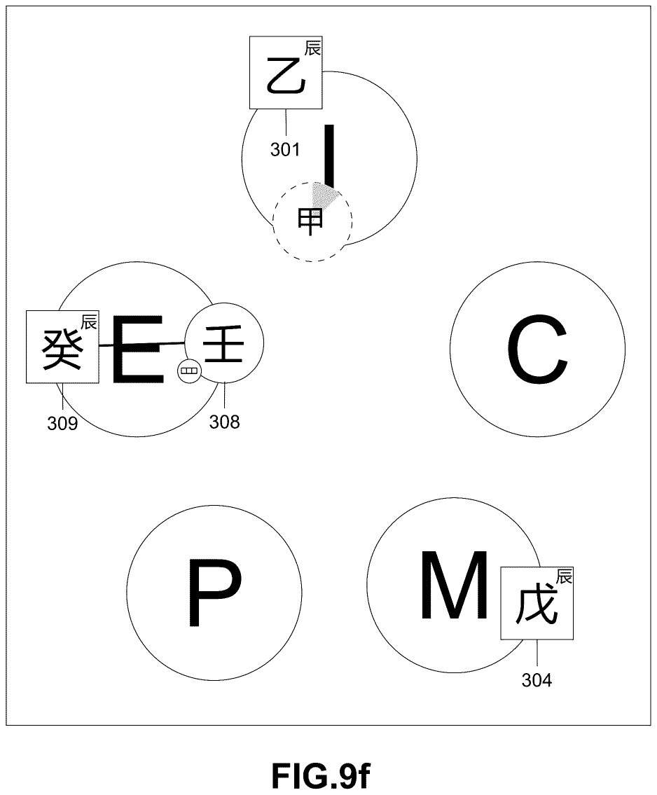

FIG. 10a a Traditional Four Pillars BaZi Astrological Table

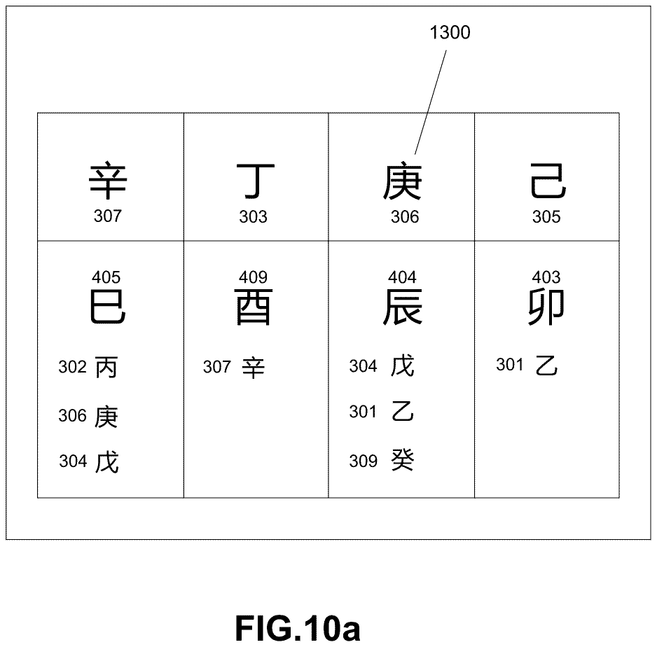

FIG. 10b Transcribing traditional BaZi astrological table using Ten Gods icons

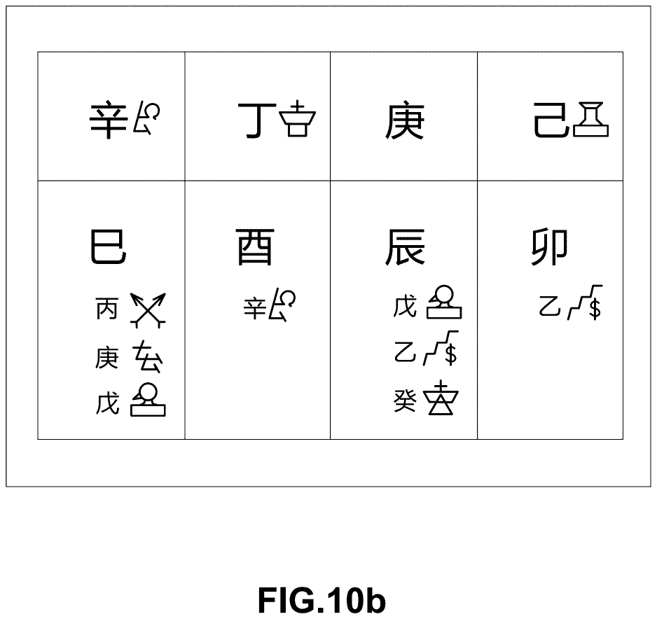

FIG. 10c Adding Ganzhi relationship icons to Ten Gods icons transcription of traditional BaZi astrological table

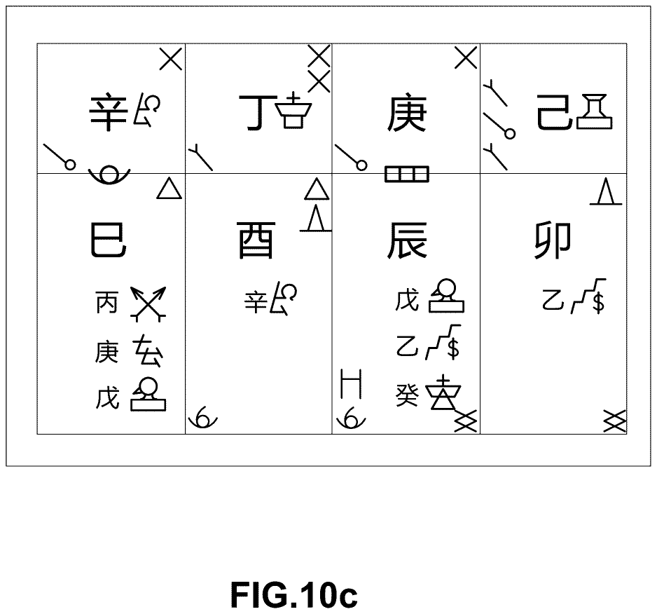

FIG. 11a Placing BaZi astrological table on the placement board according to GKSD regulations

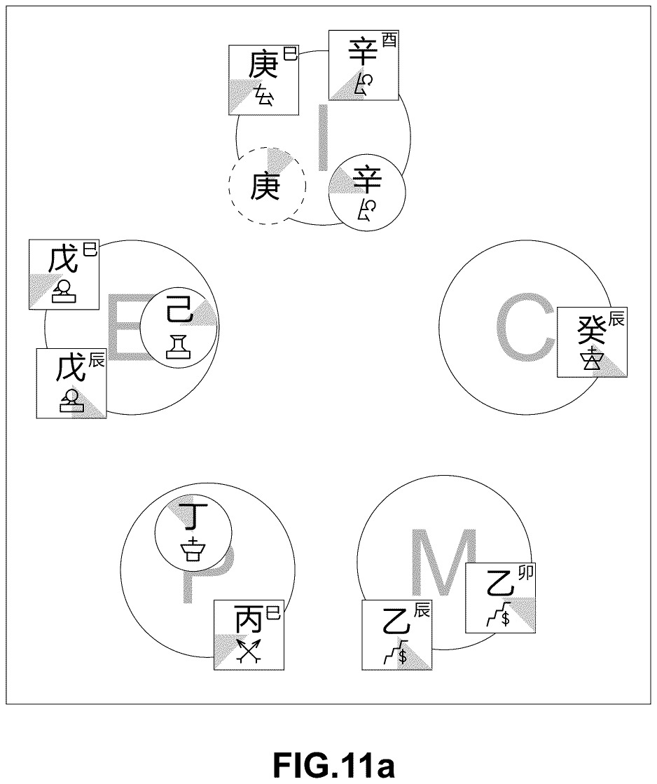

FIG. 11b Mapping transcription data to the GKSD diagram according to GKSD regulations

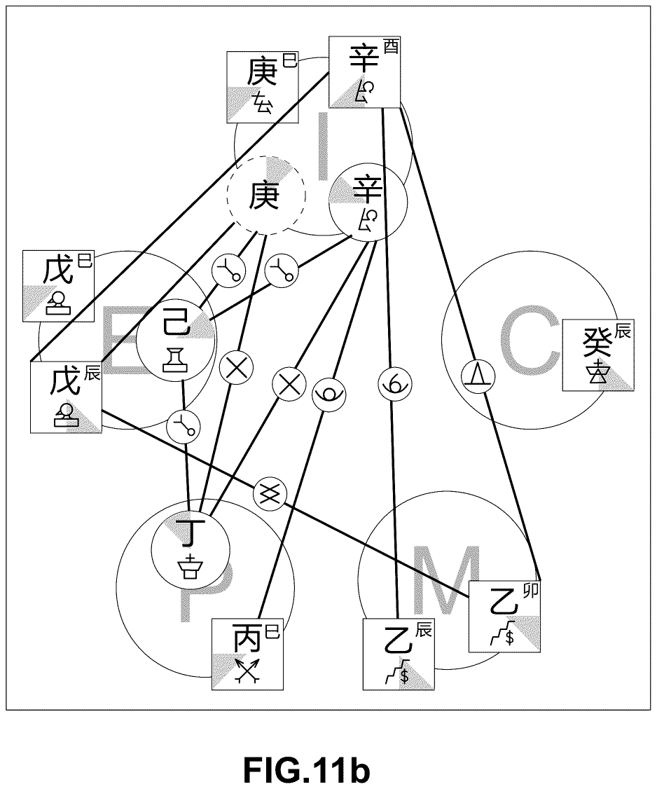

FIG. 11c Adding status icons to elements according to GKSD regulations

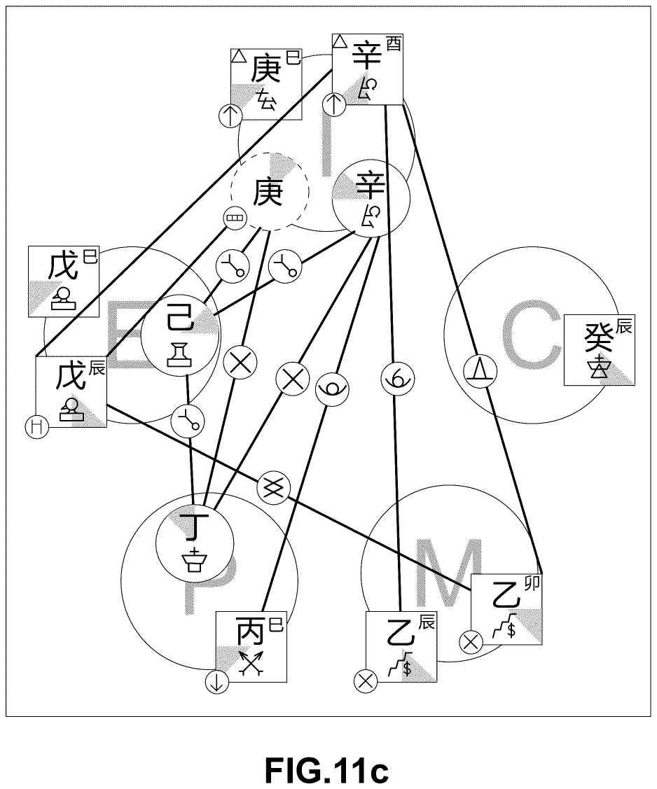

What is claimed is:

1. A multi-dimensional symbol mapping method for visualizing Ganzhi energy relationships, characterized by comprising the following steps: a) extracting traditional Four Pillars BaZi chart information; b) mapping and transcribing the extracted chart information through a standardized symbol system; c) applying predefined relationship definition rules to identify interaction relationships between elements; d) constructing a Ganzhi Karma Structure Diagram based on inner and outer circle hierarchical structure principle, with Heavenly Stem elements arranged in the inner circle and Stored Stems of Earthly Branches arranged in the outer circle; e) establishing connection relationships between elements based on relationship definition rules; f) adding graphical identifiers representing state changes to various elements according to element state mapping rules.

2. The method according to claim 1, characterized in that the standardized symbol system in step b) includes: Five Elements symbol set, used to represent the five basic elements of Metal, Wood, Water, Fire, Earth and their interaction relationships; Relationship symbol set, used to represent various interaction relationships between elements; Status symbol set, used to represent state changes of elements under relationship effects.

3. The method according to claim 1, characterized in that constructing a Ganzhi Karma Structure Diagram based on inner and outer circle hierarchical structure principle in step d) further includes: assigning elements to predefined I, C, M, P, E five functional regions according to the relationship type between elements and the Day Master; allocating shapes within each functional region according to the position attributes of elements; adding visual identifiers showing their source to elements according to the Four Pillars position of element source.

4. The method according to claim 1, characterized in that establishing connection relationships between elements in step e) includes: defining the shape, color, and thickness of connecting lines to represent different types and strengths of relationships; attaching relationship symbols to the connecting lines to represent the specific type of relationship that occurs.

5. The method according to claim 1, characterized in that the element state mapping rules in step f) include: determination and representation method of Stored Stem opening state; determination and representation method of Stored Stem closing state; determination and representation method of element energy rising state; determination and representation method of element energy falling state; determination and representation method of element damage state; determination and representation method of special states.
